(19) United States
(12) Patent Application Publication
(10) Pub. No.: US 2016/0095464 A1
(43) Pub. Date: Apr. 7, 2016

(54) Design A Drink

(71) Applicant: Steven Mark Jones, Seabrook, NH (US)

(72) Inventor: Steven Mark Jones, Seabrook, NH (US)

(73) Assignee: Steven Mark Jones, Seabrook, NH (US)

(21) Appl. No.: 14/121,660

(22) Filed: Oct. 3, 2014

(51) Int. Cl. A47J 31/44

(52) U.S. Cl. CPC A47J 31/4403

(57) ABSTRACT

An apparatus and method enabling the user to make but not limited to: any known drinking water composition and then apply this unique drinking water capability to produce a totally new kind of tasting, coffee, juice type drinks, etc. by means of adding minerals and trace elements to ultra purified water.

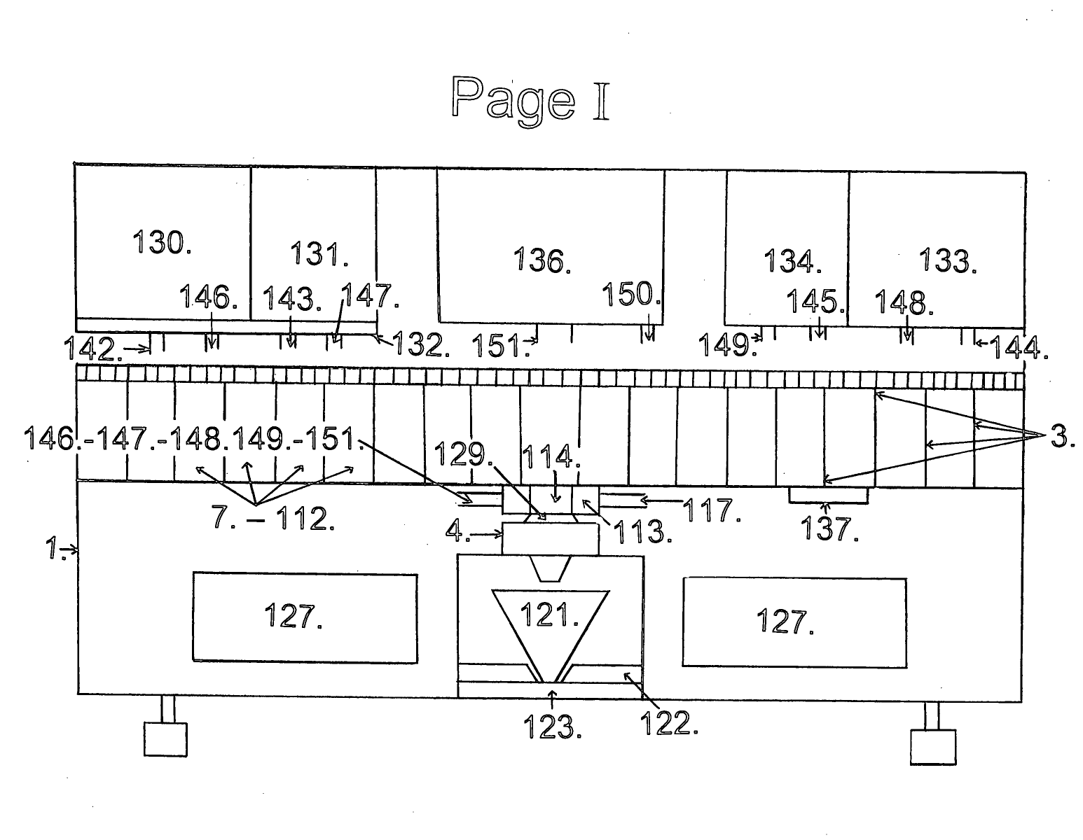

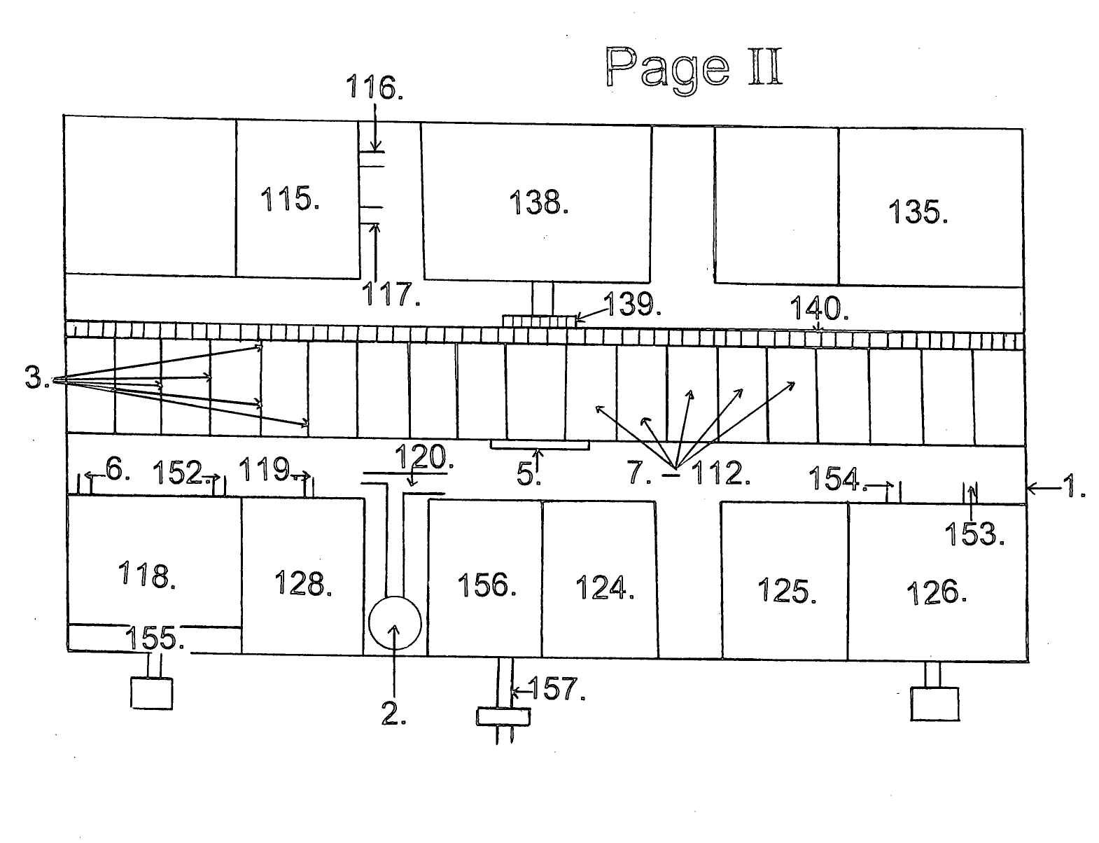

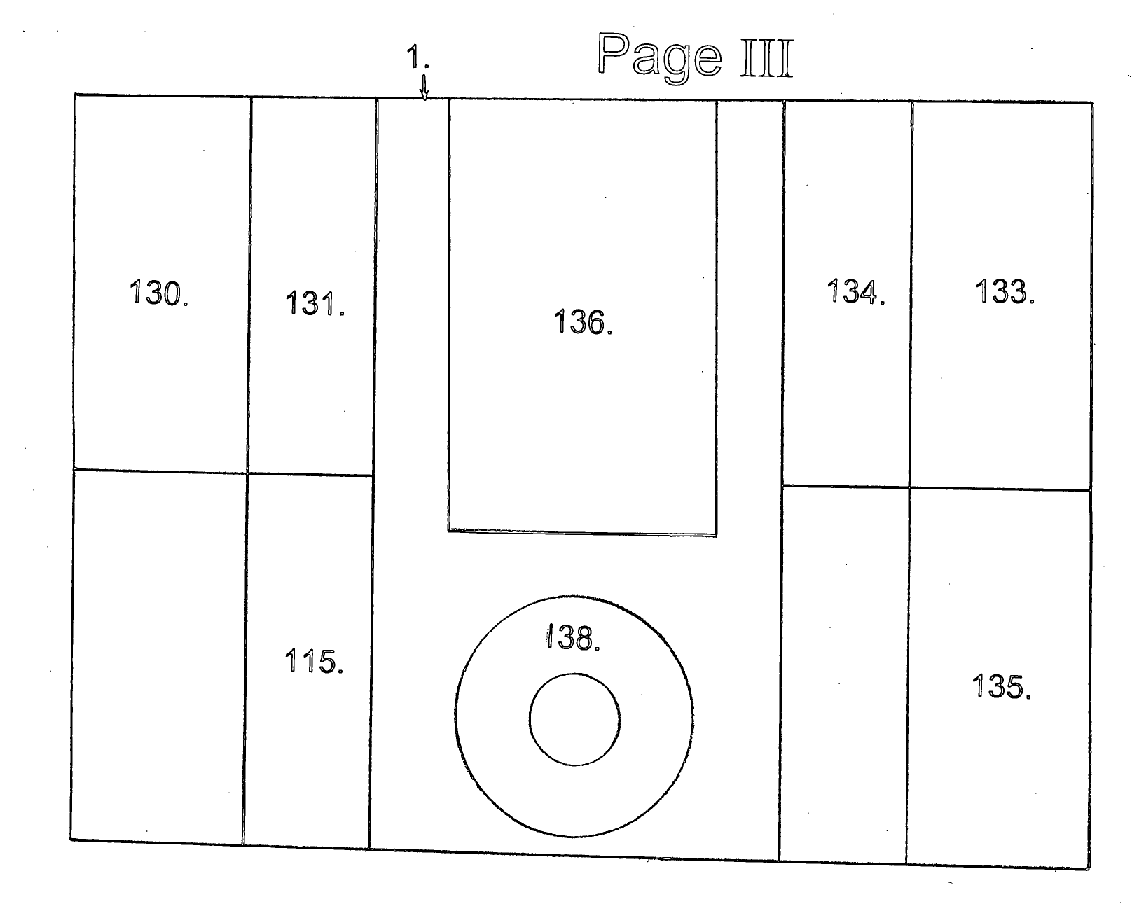

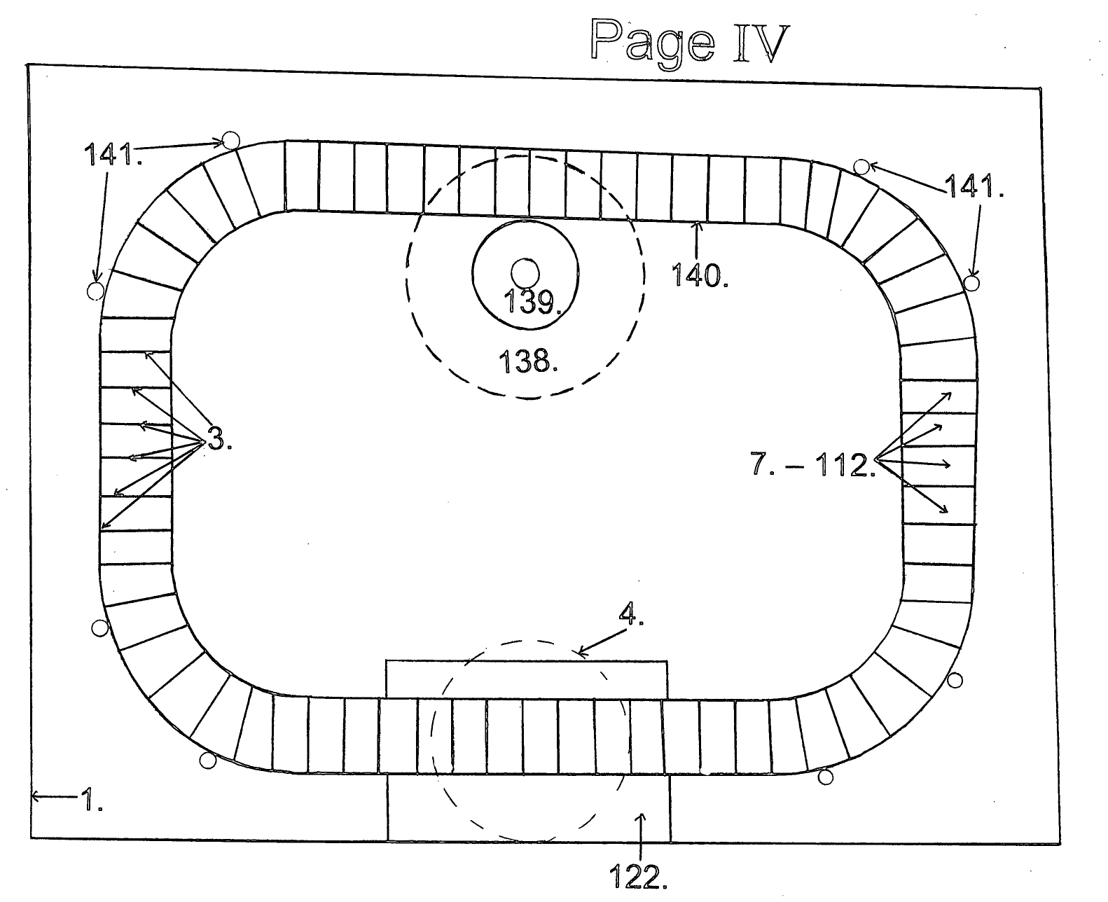

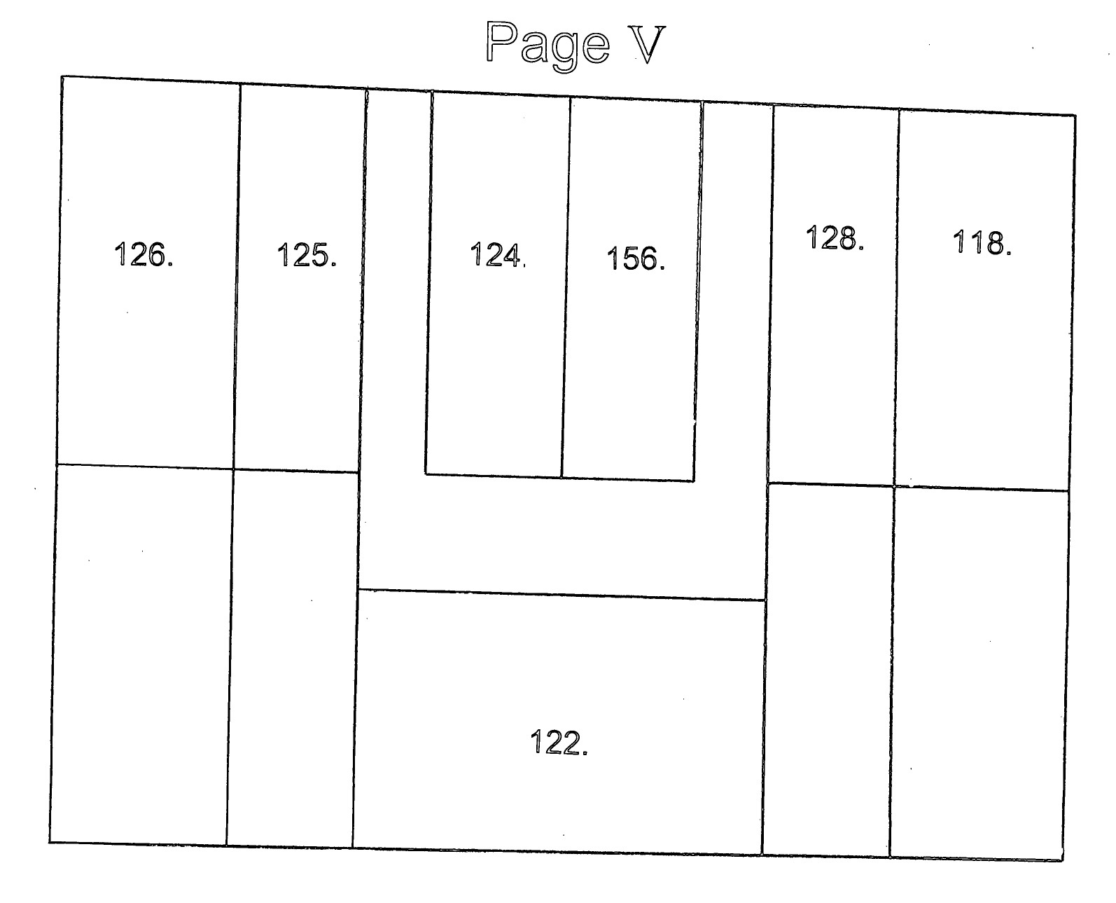

There are many different content packets, a double-distilling unit and a control panel keyboard/verbal display, microprocessor and a special dispensing system allows the user to fine tune any drink, to any acquired taste imaginable.

### CROSS-REFERENCE TO RELATED APPLICATIONS

This application is related to and claims priory from U.S. Provisional Patent Application Ser. No. 61/961,107 filed Oct. 4, 2013.

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISC

“Not Applicable”

### BACKGROUND OF THE INVENTION

1. Field of the Invention

This invention relates to an apparatus that can transform any water source i.e.; salt, city, well, etc. to ultra purified water. The user can choose to replicate any type of drinking water but not limited to, anywhere in the world, from a preloaded data bank that posses an updateable software system so to download additional data, when available from the Internet.

Then the invention mixes the ultra purified water and specially selected packet/s to produce the properly calculated water and mineral/etc. content to replicate the users programmed desired taste and ph balance of water.

More specifically to a method and apparatus for configuring and adding exact ingredients of the desired water composition from data base and then adds the ingredients to the ultra purified water.

The outcome is a consumer configured water that was made to replicate any water source known. Also, the data bank can configure the water into countless variations in mixtures as well. This specialized water replication process, opens the door into another markets, but not limited to; water, soft drink, coffee, alcohol, etc.

The apparatus can be but not limited to; as small as a counter top version for personal use at home, to a large industrial sized unit for commercial and industrial use.

2. Description of Related Art

U.S. Pat. No. 8,162,210 (Apr. 24, 2012) Brian McInerney, Justin Pigott A liquid and drink mix vending machine can vend both potable water and as an additional purchase option drink mixes (e.g., flavored drink mixes). The vending machine can include a liquid vending system and a drink mix vending system.

The liquid vending system can vend different amounts of water, which can be delivered to a container provided by a user. The drink mix vending system can vend a variety of drink mixes, including drink mixes of different concentrations for a given quantity of water.

Problems with the above-noted prior art include, the system that adds a variety of drink mixes for a given quantity of water. Therefore, the ingredients added are for flavoring conventional drinking water, to produce a certain taste.

The present invention addresses these shortcomings by focusing on adding a variety of minerals and/or trace elements for a given quantity of ultra purified water. Therefore, the minerals and/or trace elements added are for but not limited to, replicating any drinking water anywhere on earth.

This is archived by mixing in exact ratios of one or more minerals and/or trace elements to the ultra purified water. This invention is not limited to what type of finely tailored minerals and/or trace elements to ultra purified water the user would like.

After the user chooses what type of drinking water composition he/she prefers. Then the user can choose what type of drink mix they would like to add to their specially tailored drinking water composition.

This finely tailored drinking water composition with its properly calculated minerals and/or trace elements added to the ultra purified water content can later be added to a conventional drink machine as an input water option.

The invention enables a totally new tasting drink due to the ability to configure and replicate but not limited to any know drinking water source, on demand.

There have been improvements in the soft drink dispensing field for some time now. They have systems that add packets of soft drink concentrated with water.

This invention is solely designed to take ultra purified water containing little to no minerals and/or trace elements and then have packets of minerals and/or trace elements precisely added to the ultra purified water to replicate any drinking water source on earth as well as any or all water mixtures beyond what's available.

### DETAILED DESCRIPTION OF THE INVENTION

The water formula is H₂O, two atoms of hydrogen and one atom of oxygen. This is water at it's purest form and only distilled water has this structure. This invention takes but not limited to, ultra. pure double distilled water and it is referred here as “ultra purified water”. The invention uses the ultra purified water as the base stock ingredient to be built on, to enable the user to custom design their own drinking water.

The invention can add one or more mineral/s and/or trace element/s to the ultra purified water and can replicate the composition of any know drinking water source on earth, by calculating and mixing in exact amounts of minerals and/or trace elements to a predetermined volume of ultra purified water.

This unique capability also allows the user to produce a drinking water composition that has never been seen on earth. This is due to the large amounts minerals and trace elements that can be chosen and added and the almost limitless variations of quantity of type of minerals and trace elements that can be chosen and added to a predetermined volume ultra purified water.

This invention opens up a totally new horizon on consumer driven drinking water taste, by enabling the consumer to choose any tasting water imaginable. With this in mind, the invention is not a conventional drink machine, the following sets the invention apart from all other drink machines available today.

The invention uses as few as one to many different content packets to be added to the ultra purified water, replicating any drinking water in the world. With it's countless combinations of minerals and trace elements available to choose from, enabling the invention to produce countless different drinking water, in taste, ph balance, etc.

This capability enables the invention to also replicate any drink in the world as well as any drinking water in the world from the use of as few as one, to many different content packets. The content packets can also have almost any ingredients imaginable to replicate, any drink imaginable.

All other drink machines mix their filtered water or conventional tap water with ingredients to produce a certain type of soda, juice, etc.

What this invention presents is a truly unique capability, the user can not only choose what type of drink they want, similar to the newer conventional drink machines offer.

But the user can first choose, what type of drinking water composition they would like “mixed in” with their favorite drink, from a long list of detailed drinking water composition of minerals and trace elements within the microprocessors data bank.

The data bank contains all known drinking water compositions with their minerals and trace elements throughout the world. This capability sets this invention apart from all the other drink machines today.

This invention is capable of producing a totally new tasting drink, never tasted before. Therefore capable of producing a a novel tasting drink even when mixed with known available drink mix.

This is due to the many different drinking water compositions and taste the user can choose to mix in with their known available drink mix. This invention steps way beyond what is even available or achievable, from today's drink machines, in both taste of the drink and flexibility in fine tuning of the taste, of the drink.

The user decides what part of the world they would like their drinking water to be replicated from. If the user don't like any of the know drinking water compositions on earth.

The user can custom configure their own minerals and trace elements content ratios per given volume of ultra purified water and produce a drinking water composition not know on earth. This unique drinking water composition can be then be used as the base ingredient for their drinking water preference or mixed into their favorite drink.

### 1. The Basic Function of the Invention

First, if the user wants a water drink, he/she can pick any drinking water type from the (127) display/verbal keyboard and in the (128) microprocessors large data base which contain every drinking water known, in the world.

Also every minerals and trace elements, ph balance and other ingredients are in the data base from every drinking water type in the world and a custom blend of two or more drinking water type, can be configured as well. Also the user has the capability to configure countless more water minerals and trace elements compositions, not found in the data bank.

Then the (128) microprocessor calculates the users request on the type of drinking water composition and custom configures the ultra purified water, used as the base stock ingredient for the drink and the properly calculated amounts of mineral/s and trace element/s required to produce the drink within the content packets.

### 2. The Comprehensive Function of the Invention for a Cold Drink

The user can choose from the (127) keyboard/verbal display panel a specially selected drinking water composition from but not limited to; for instance, Alaska.

Then the (128) microprocessor scans its data bank and calculates the exact water composition, from Alaska. Then the (128) microprocessor calculates the (7-112) content/s packets required to replicate the water composition from Alaska.

Then the (128) microprocessor sends a signal from the (119) input and output leads to the (138) electric motor and engage the motor, this turns the (139) electric motor gear which is connected to the (140) content packet holder conveyor gear, so that the (141) content packet holder conveyor system operate and the (7-112) content/s packets move and they pass and over the (4) mixing manifold.

There is a (137) content packet positioning system that is directly connected to the (128) microprocessor and sends a signal to the (119) input and output leads, enabling the (128) microprocessor to monitor the exact location of the (7-112) content packets on the (141) content packet holder conveyor system.

Then when the required (7-112) content packet is in the exact position over the (4) content mixing manifold, the (128) microprocessor would send a signal from the (119) input and output leads to the (138) electric motor and stops the motor.

Then the (128) microprocessor sends a signal to the (119) input and output leads to the (113) content holder vibrator that mildly shakes the contents within the (7-112) content packets.

This opens a (161) vibrating sensor valve o(7-112) content packets and the contents within packets, begin to come out. The n the bottom of each of the mild vibration eliminates clumping and keeps the dry elements in a fine powered state and the liquid elements evenly mixed.

Then the (128) microprocessor would sends a signal to the (119) input and output leads to the (115) electric air pump. The air flow offers a medium for the contents within the (7-112) content packets to be forced into the (4) content mixing manifold in a controlled manner.

There is a (129) laser flow meter, that is directly connected to the (128) microprocessor by means of the (119) input and output leads. The (129) laser flow meter feeds information to the (128) microprocessor, enabling it to fully

control the exact metering, that is required to regulate the amount of flow and quantity of the dry and liquid contents from the (7-112) content packet to the (4) content mixing manifold.

There is a (114) content holder electric metering valve to ensure the exact amount of contents from the (7-112) content packets and ultra purified water are placed into the desired drink.

Then when the precise amount of chosen content is dispensed from the (7-112) content packet into the (4) mixing manifold. The (129) laser flow meter that is directly connected to the (128) microprocessor, sends a signal to the (119) input and output leads, which enables the (128) microprocessor to send a signal to the (119) input and output leads, to the (113) content holder vibrator and the (115) electric air pump and they stop operating.

This causes the content from within the (7-112) content packet to cease coming out. The action mentioned above, represents the exact amount of content needed from the (7-112) content packet to the (4) mixing manifold.

If two or more contents are required from the (7-112) content packets, the (128) microprocessor will repeat the actions mentioned above, until all the required contents from the (7-112) content packets from the acquired information in data base in the (128) microprocessor, needed for the required drink set by the user, are precisely measured and dispersed into the (4) content mixing manifold.

Once all the required contents from the (7-112) content packets are placed into the (4) content mixing manifold, then the (128) microprocessor sends a signal to the (119) input and output leads to the (159) electric water valve on the ultra purified cold water outlet line with built in one way valve.

The (159) electric water valve on the ultra purified cold water outlet line with built in one way valve will open and disperse the exact quantity of ultra purified cold water from the (133) insulated ultra purified cold water holding tank. The (133) insulated ultra purified cold water holding tank is constantly kept filled by means of the (118) double-distilling unit and the (2) water intake source.

The ultra purified cold water will flow through the (159) electric water valve on the ultra purified cold water outlet line with built in one way valve and through the (148) ultra purified cold water outlet line with built in one way valve and into the (144) ultra purified cold water inlet line with built in one way valve, which is directly connected to the (4) content mixing manifold.

Now when the cold ultra purified water enters the (4) content mixing manifold, all the contents within the (4) content packets are combined with the ultra purified cold water. Mixing the ingredients within the (4) content mixing manifold, before it is dispersed into the (121) cup/bottle.

The design of the (4) content mixing manifold and the (148) ultra purified cold water outlet line with built in one way valve are in such a manner that when the ultra purified cold water enters the (4) content mixing manifold, there is a swirling self cleaning action, leaving no residue of the contents from the (7-112) content packets in the (4) content mixing manifold.

The desired drink is dispensed into the (121) cup/bottle, from the (4) content mixing manifold and the (4) content mixing manifold will be clean for the next cycle of drink requirements.

While the now mixed ultra purified cold water and contents begin to exit the (4) content mixing manifold, the (128) microprocessor with its (119) input and output leads sends a signal to the (123) ultrasonic mixer to ensure the ultra purified cold water with all the contents are fully and evenly combined.

The user can reach in and take the (121) cup/bottle and the user has an unique specially designed drink that he custom configured, by means of the invention that no other machine can perform, to date. Producing a truly one of a kind cold drink on demand.

### 3. The Comprehensive Function of the Invention for a Carbonated Cold Drink

The user can choose from the (127) keyboard/verbal display panel a specially selected drinking water composition from but not limited to; for instance, Alaska.

Then the (128) microprocessor scans its data bank and calculates the exact water composition, from Alaska. Then the (128) microprocessor calculates the (7-112) content/s packets required to replicate the water composition from Alaska.

Then the (128) microprocessor sends a signal from the (119) input and output leads to the (138) electric motor and engage the motor, this turns the (139) electric motor gear which is connected to the (140) content packet holder conveyor gear, so that the (141) content packet holder conveyor system operate and the (7-112) content/s packets move and they pass and over the (4) mixing manifold.

There is a (137) content packet positioning system that is directly connected to the (128) microprocessor and sends a signal to the (119) input and output leads, enabling the (128) microprocessor to monitor the exact location of the (7-112) content packets on the (141) content packet holder conveyor system.

Then when the required (7-112) content packet is in the exact position over the (4) content mixing manifold, the (128) microprocessor would send a signal from the (119) input and output leads to the (138) electric motor and stops the motor.

Then the (128) microprocessor sends a signal to the (119) input and output leads to the (113) content holder vibrator that mildly shakes the contents within the (7-112) content packets.

This opens a (161) vibrating sensor valve on the bottom of each of the (7-112) content packets and the contents within packets, begin to come out. The mild vibration eliminates clumping and keeps the dry elements in a fine powered state and the liquid elements evenly mixed.

Then the (128) microprocessor would sends a signal to the (119) input and output leads to the (115) electric air pump. The air flow offers a medium for the contents within the (7-112) content packets to be forced into the (4) content mixing manifold in a controlled manner.

There is a (129) laser flow meter, that is directly connected to the (128) microprocessor by means of the (119) input and output leads. The (129) laser flow meter feeds information to the (128) microprocessor, enabling it to fully control the exact metering, that is required to regulate the amount of flow and quantity of the dry and liquid contents from the (7-112) content packet to the (4) content mixing manifold.

There is a (114) content holder electric metering valve to ensure the exact amount of contents from the (7-112) content packets and ultra purified water are placed into the desired drink.

Then when the precise amount of chosen content is dispensed from the (7-112) content packet into the (4) mixing manifold. The (129) laser flow meter that is directly connected to the (128) microprocessor, sends a signal to the (119) input and output leads, which enables the (128) microprocessor to send a signal to the (119) input and output leads, to the (113) content holder vibrator and the (115) electric air pump and they stop operating.

This causes the content from within the (7-112) content packet to cease coming out. The action mentioned above, represents the exact amount of content needed from the (7-112) content packet to the (4) mixing manifold.

If two or more contents are required from the (7-112) content packets, the (128) microprocessor will repeat the actions mentioned above, until all the required contents from the (7-112) content packets from the acquired information in data base in the (128) microprocessor, needed for the required drink set by the user, are precisely measured and dispersed into the (4) content mixing manifold.

Once all the required contents from the (7-112) content packets are placed into the (4) content mixing manifold, then the (128) microprocessor sends a signal to the (119) input and output leads to the (162) ultra purified carbonating water system electric valve.

The (162) ultra purified carbonating water system electric valve with built in one way valve will open and disperse the exact quantity of ultra purified carbonating cold water from the (126) insulated ultra purified carbonated cold water system/holding tank. The (126) insulated ultra purified carbonated cold water system/holding tank is constantly kept filled by means of the (118) double-distilling unit and the (2) water intake source.

The ultra purified carbonated cold water will flow through the (162) ultra purified carbonating water system electric valve with built in one way valve and through the (154) insulated ultra purified carbonated cold water system/holding tank water outlet line with built in one way valve and into the (153) insulated ultra purified carbonated cold water system/holding tank water inlet line with built in one way valve, which is directly connected to the (4) content mixing manifold.

Now when the ultra purified carbonated cold water enters the (4) content mixing manifold, all the contents within the (4) content packets are combined with the ultra purified carbonated cold water. Mixing the ingredients within the (4) content mixing manifold, before it is dispersed into the (121) cup/bottle.

The design of the (4) content mixing manifold and the (153) insulated ultra purified carbonated cold water system/holding tank water inlet line with built in one way valve are in such a manner that when the ultra purified carbonated cold water enters the (4) content mixing manifold, there is a swirling self cleaning action, leaving no residue of the contents from the (7-112) content packets in the (4) content mixing manifold.

The desired drink is dispensed into the (121) cup/bottle, from the (4) content mixing manifold and the (4) content mixing manifold will be clean for the next cycle of drink requirements.

While the now mixed ultra purified carbonated cold water and contents begin to exit the (4) content mixing manifold, the (128) microprocessor with its (119) input and output leads sends a signal to the (123) ultrasonic mixer to ensure the ultra purified carbonated cold water with all the contents are fully and evenly combined.

The user can reach in and take the (121) cup/bottle and the user has an unique specially designed drink that he custom configured, by means of the invention that no other machine can perform, to date. Producing a truly one of a kind carbonated cold water drink on demand.

### 4. The Comprehensive Function of the Invention for a Hot Drink

The user can choose from the (127) keyboard/verbal display panel a specially selected drinking water composition from but not limited to; for instance, Alaska. Then the (128) microprocessor scans its data bank and calculates the exact water composition minerals and trace elements, from Alaska.

Then the (128) microprocessor calculates the (7-112) content/s packets required to replicate the water composition from Alaska. Then the (128) microprocessor sends a signal from the (119) input and output leads to the (138) electric motor and engage the motor.

This turns the (139) electric motor gear which is connected to the (140) content packet holder conveyor gear, so that the (141) content packet holder conveyor system operate and the (7-112) content/s packets move and they pass and over the (4) mixing manifold.

There is a (137) content packet positioning system that is directly connected to the (128) microprocessor and sends a signal to the (119) input and output leads, enabling the (128) microprocessor to monitor the exact location of the (7-112) content packets on the (141) content packet holder conveyor system.

Then when the required (7-112) content packet is in the exact position over the (4) content mixing manifold, the (128) microprocessor would send a signal from the (119) input and output leads to the (138) electric motor and stops the motor.

Then the (128) microprocessor sends a signal to the (119) input and output leads to the (113) content holder vibrator that mildly shakes the contents within the (7-112) content packets. This opens a (161) vibrating sensor valve on the bottom of each of the (7-112) content packets and the contents within packets, begin to come out. The mild vibration eliminates clumping and keeps the dry elements in a fine powered state and the liquid elements evenly mixed.

Then the (128) microprocessor would sends a signal to the (119) input and output leads to the (115) electric air pump. The air flow offers a medium for the contents within the (7-112) content packets to be forced into the (4) content mixing manifold in a controlled manner.

There is a (129) laser flow meter, that is directly connected to the (128) microprocessor by means of the (119) input and output leads. The (129) laser flow meter feeds information to the (128) microprocessor, enabling it to fully control the exact metering, that is required to regulate the amount of flow and quantity of the dry and liquid contents from the (7-112) content packet to the (4) content mixing manifold.

There is a (114) content holder electric metering valve to ensure the exact amount of contents from the (7-112) content packets and ultra purified water are placed into the desired drink.

Then when the precise amount of the chosen content is dispensed from the (7-112) content packet into the (4) mixing manifold. The (129) laser flow meter that is directly connected to the (128) microprocessor, sends a signal to the (119) input and output leads, which enables the (128) microprocessor to send a signal to the (119) input and output leads, to the (113) content holder vibrator and the (115) electric air pump and they stop operating.

This causes the content from within the (7-112) content packet to cease coming out. The action mentioned above, represents the exact amount of content needed from the (7-112) content packet to the (4) mixing manifold.

If two or more contents are required from the (7-112) content packets, the (128) microprocessor will repeat the actions mentioned above, until all the required contents from the (7-112) content packets from the acquired information in data base in the (128) microprocessor, needed for the required drink set by the user, are precisely measured and dispersed into the (4) content mixing manifold.

Once all the required contents from the (7-112) content packets are placed into the (4) content mixing manifold, then the (128) microprocessor sends a signal to the (119) input and output leads to the (158) electric water valve on the (146) ultra purified water hot water outlet line with built in one way valve.

The (158) electric water valve on the ultra purified hot water outlet line with built in one way valve will open and disperse the exact quantity of ultra purified hot water from the (130) insulated ultra purified hot water holding tank. The (130) insulated ultra purified hot water holding tank is constantly kept filled by means of the (118) double-distilling unit and the (2) water intake source.

The ultra purified hot water will flow through the (158) electric water valve on the ultra purified hot water outlet line with built in one way valve and through the (146) ultra purified hot water outlet line with built in one way valve and into the (142) ultra purified hot water inlet line with built in one way valve, which is directly connected to the (4) content mixing manifold.

Now when the hot ultra purified water enters the (4) content mixing manifold, all the contents within the (4) content packets are combined with the ultra purified hot water. Mixing the ingredients within the (4) content mixing manifold, before it is dispersed into the (121) cup/bottle.

The design of the (4) content mixing manifold and the (146) ultra purified hot water outlet line with built in one way valve are in such a manner that when the ultra purified hot water enters the (4) content mixing manifold, there is a swirling self cleaning action, leaving no residue of the contents from the (7-112) content packets in the (4) content mixing manifold.

The desired drink is dispensed into the (121) cup/bottle, from the (4) content mixing manifold and the (4) content mixing manifold will be clean for the next cycle of drink requirements.

While the now mixed ultra purified hot water and contents begin to exit the (4) content mixing manifold, the (128) microprocessor with its (119) input and output leads sends a signal to the (123) ultrasonic mixer, to ensure the ultra purified hot water with all the contents are fully and evenly combined.

The user can reach in and take the (121) cup/bottle and the user has an unique specially designed drink that he custom configured, by means of the invention that no other machine can perform, to date. Producing a truly one of a kind hot drink on demand.

### 5. The Comprehensive Function of the Invention for a Slush Drink

The user can choose from the (127) keyboard/verbal display panel a specially selected drinking water composition from but not limited to; for instance, Alaska.

Then the (128) microprocessor scans its data bank and calculates the exact water composition, from Alaska. Then the (128) microprocessor calculates the (7-112) content/s packets required to replicate the water composition from Alaska.

Then the (128) microprocessor sends a signal from the (119) input and output leads to the (138) electric motor and engage the motor, this turns the (139) electric motor gear which is connected to the (140) content packet holder conveyor gear, so that the (141) content packet holder conveyor system operate and the (7-112) content/s packets move and they pass and over the (4) mixing manifold.

There is a (137) content packet positioning system that is directly connected to the (128) microprocessor and sends a signal to the (119) input and output leads, enabling the (128) microprocessor to monitor the exact location of the (7-112) content packets on the (141) content packet holder conveyor system.

Then when the required (7-112) content packet is in the exact position over the (4) content mixing manifold, the (128) microprocessor would send a signal from the (119) input and output leads to the (138) electric motor and stops the motor.

Then the (128) microprocessor sends a signal to the (119) input and output leads to the (113) content holder vibrator that mildly shakes the contents within the (7-112) content packets.

This opens a (161) vibrating sensor valve on the bottom of each of the (7-112) content packets and the contents within packets, begin to come out. The mild vibration eliminates clumping and keeps the dry elements in a fine powered state and the liquid elements evenly mixed.

Then the (128) microprocessor would sends a signal to the (119) input and output leads to the (115) electric air pump. The air flow offers a medium for the contents within the (7-112) content packets to be forced into the (4) content mixing manifold in a controlled manner.

There is a (114) content holder electric metering valve to ensure the exact amount of contents from the (7-112) content packets and ultra purified water are placed into the desired drink.

There is a (129) laser flow meter, that is directly connected to the (128) microprocessor by means of the (119) input and output leads. The (129) laser flow meter feeds information to the (128) microprocessor, enabling it to fully control the exact metering, that is required to regulate the amount of flow and quantity of the dry and liquid contents from the (7-112) content packet to the (4) content mixing manifold.

Then when the precise amount of chosen content is dispensed from the (7-112) content packet into the (4) mixing manifold. The (129) laser flow meter that is directly connected to the (128) microprocessor, sends a signal to the (119) input and output leads, which enables the (128) microprocessor to send a signal to the (119) input and output leads, to the (113) content holder vibrator and the (115) electric air pump and they stop operating.

This causes the content from within the (7-112) content packet to cease coming out. The action mentioned above, represents the exact amount of content needed from the (7-112) content packet to the (4) mixing manifold.

If two or more contents are required from the (7-112) content packets, the (128) microprocessor will repeat the actions mentioned above, until all the required contents from the (7-112) content packets from the acquired information in data base in the (128) microprocessor, needed for the required drink set by the user, are precisely measured and dispersed into the (4) content mixing manifold.

Once all the required contents from the (7-112) content packets are placed into the (4) content mixing manifold, then the (128) microprocessor sends a signal to the (119) input and output leads to the (160) electric water valve on the ultra purified slush water outlet line with built in one way valve.

The (160) electric water valve on the ultra purified slush water outlet line with built in one way valve will open and disperse the exact quantity of ultra purified slush water from the (136) ultra purified slush water insulated maker and holding tank. The (136) insulated ultra purified slush maker water holding tank is constantly kept filled by means of the (118) double-distilling unit and the (2) water intake source.

The ultra purified slush water will flow through the (160) electric water valve on the ultra purified slush water outlet line with built in one way valve and through the (151) ultra purified slush water outlet line with built in one way valve and into the (150) ultra purified slush water inlet line with built in one way valve, which is directly connected to the (4) content mixing manifold.

Now when the ultra purified slush water enters the (4) content mixing manifold, all the contents within the (4) content packets are combined with the ultra purified slush water. Mixing the ingredients within the (4) content mixing manifold, before it is dispersed into the (121) cup/bottle.

The design of the (4) content mixing manifold and the (151) distilled slush water outlet line with built in one way valve are in such a manner that when the ultra purified slush water enters the (4) content mixing manifold, there is a swirling self cleaning action, leaving no residue of the contents from the (7-112) content packets in the (4) content mixing manifold.

The desired drink is dispensed into the (121) cup/bottle, from the (4) content mixing manifold and the (4) content mixing manifold will be clean for the next cycle of drink requirements.

While the now mixed ultra purified slush water and contents begin to exit the (4) content mixing manifold, the (128) microprocessor with its (119) input and output leads sends a signal to the (123) ultrasonic mixer to ensure the ultra purified slush water with all the contents are fully and evenly combined.

The user can reach in and take the (121) cup/bottle and the user has an unique specially designed drink that he custom configured, by means of the invention that no other machine can perform, to date. Producing a truly one of a kind slush drink on demand.

6.Drinks that Can Be Made with the Invention, but not Limited to:

1. Spring water from any place on earth. This is due to the comprehensive data base stored within unit. The invention uses distilled water as a base, then adds the needed ingredients from the content packets (7-112) to replicate any water in the world with but not limited to: the proper minerals and PH balance.

The user can also mix two or more waters if desired. For instance: mix spring water from Maui, Hawaii with the spring water from the Amazon rain forest to produce a spring water that was never tasted before this invention.

2. The spring water can be configured to contain 100% of the daily allowance of vitamins if required and can have caffeine or any other ingredient added as well.

3. Coffee from any place on earth with the comprehensive data base stored within unit. As well as any mixture of two or more coffees. To produce a coffee that was never tasted before this invention.

4. Mixture of coffee and spring water combined in any order, from any place on earth with the comprehensive data base stored within unit.

5. Flavored coffee and spring water combined in any order, from any place on earth with the comprehensive data base stored within unit.

6. Tea from any place on earth with the comprehensive data base stored within unit. As well as any mixture of two or more. To produce a tea that was never tasted before this invention.

7. Mixture of tea and spring water combined in any order, from any place on earth with the comprehensive data base stored within unit.

8. Flavored tea and spring water combined in any order, from any place on earth with the comprehensive data base stored within unit.

9. The desired coffee and tea can also be fine tuned with the caffeine content from total decaffeinated to very high levels of caffeine.

10. Vitamins and anti oxidants can be added as well.

11. All off the shelf energy drinks can be configured and replicated with this invention. As well as any mixture of two or more types of drinks.

12. The user can also fine tune their drink with vitamins and higher or lower energy needs.

13. All off the shelf fruit drinks can be configured and replicated with this invention. As well as any mixture of two or more juices.

14. The user can also fine tune their drink with vitamins and higher or lower fruit flavor to suit their needs. As well as any mixture of two or more types of drinks.

15. All off the shelf soda drinks can be configured and replicated with this invention.

16. The user can also fine tune their drink with vitamins and higher or lower soda flavor to suit their needs.

17. All off the shelf dairy drinks can be configured and replicated with this invention. As well as any mixture of two or more types of drinks.

18. The user can also fine tune their drink with chocolate, vanilla, strawberry, etc, vitamins and can set from 0% fat to whole milk and cream.

19. All off the shelf protein drinks can be configured and replicated with this invention. As well as any mixture of two or more types of drinks.

20. The user can also fine tune their drink with vitamins and higher or lower flavor, percentage of vitamins, protein and other ingredients to suit their needs.

21. All off the shelf sports drinks can be configured and replicated with this invention. As well as any mixture of two or more types of drinks.

22. The user can also fine tune their drink with vitamins and higher or lower flavor, percentage of ingredients and vitamins to suit their needs.

23. All off the shelf vegetable drinks can be configured and replicated with this invention. As well as any mixture of two or more types of drinks.

24. The user can also fine tune their drink with vitamins and higher or lower flavor, percentage of vitamins to suit their needs and to protect from food allergies.

25. Healthy vitamin enriched frozen pops, with any flavor and any mix of flavor imaginable. Just pour the drink into a pop maker and place in the freezer.

26. All off the shelf ice creams can be configured and replicated with this invention. As well as any mixture of two or more types. Just pour the drink into an ice cream holder and place in the freezer.

27. The user can also fine tune their ice cream with vitamins and higher or lower flavor, percentage of vitamins and/or protein to suit their needs. Also food allergies can be programmed into the microprocessor and make sure the ice cream don't have any dangerous ingredients.

28. All off the shelf beer drinks can be configured and replicated with this invention. As well as any mixture of two or more types of drinks.

29. The user can also fine tune their drink with vitamins and higher or lower beer flavor to suit their needs, as well as percentage of alcohol content from no alcohol to high levels of alcohol.

30. All off the shelf wine drinks can be configured and replicated with this invention. As well as any mixture of two or more types of drinks.

31. The user can also fine tune their drink with vitamins and higher or lower wine flavor to suit their needs, as well as percentage of alcohol content from no alcohol to high levels of alcohol.

32. There can be a medicine content packets as well. This would enable the user to dispense cough medicine with fruit juice for children if desired.

33. The medicine content packets can mix a blend of medication for the user and make a tasty drink for the user to consume.

34. There can be an aspirin-cold medicine content packet to provide a nice hot spice tea with the medicine with vitamin C and other ingredients.

### SPECIFICATION

There is a (1) base of the apparatus, within the base there are the following: (2) a water intake source, this is the source of water for the invention to operate. There are one or more (3) dry and liquid content packet holders and a (4) content mixing manifold, that mixes the ingredients from the (7-112) content packets.

There is a (5) content gauge that monitors the content level of each of the ingredients within the (7-112) content packets and sends a signal to the (128) microprocessor and on the (127) keyboard/verbal display, notifying the user when the (7-112) content packet/s need refilling.

There is a (145) water inlet line with built in one way valve, the one way valve avoids back flow of fluid to the (118) double-distilling unit. There are many different (7-112) contents packets that can be chosen, to be within the packet holders (3) and they are as follows, but not limited to: (7-98) are the dry content packets and (99-112) are the liquid content packets.

These (7-112) content packets are just examples of a much larger variety of ingredients that can be installed into the (3) packet holders and there can be but not limited to: a one or more, small (3) packet holders for a small base model to, many rows of large (3) packet holders for a large commercial model, to hold all the required content packets (7-112) to produce the desired drink/s.

There is a (113) content holder vibrator that mildly shakes the contents within the (7-112) content packets to eliminate clumping and keep the dry contents in a fine powered state and the liquid contents evenly mixed.

A (161) vibrating sensor valve is placed on the bottom of the (3) content packet holders, so to open and release the contents within the packets when the (113) content holder vibrator is engaged.

There is a (129) laser flow rate meter that is directly connected to the (128) microprocessor that monitors the content flow into the (4) content mixing manifold.

This capability ensures precise metering to the (114) content holder electric metering valve the the exact amount of contents from the (7-112) content packets are placed into the desired drink within the but not limited to: (121) cup, bottle, held by a (122) mixing drink holder. There is an (115) electric air pump that offers a medium for the contents within the (7-112) content packets to be forced into the (4) content mixing manifold.

There is a (118) double-distilling unit that produces highly purified laboratory type water, that has almost all the minerals and trace essentials removed and it is referred to as highly purified water. The produced highly purified water is used as a base ingredient for any drink to be built with, when required. There are (119) input and output leads to and from the(128) microprocessor to all systems.

There is a (122) mixing drink holder and within there is an (123) ultrasonic mixer, this device allows the chosen (7-112) content packet/s to be completely mixed with highly purified water and/or tap water, producing a perfectly mixed drink after it leaves the (4) content mixing manifold.

There is a (124) carbon dioxide generator that produces carbon dioxide and stores the gas in the (125) carbon dioxide holding tank, that feeds into the (126) insulated ultra purified carbonated cold water system/holding tank.

If the user decides to make a carbonated drink, then the (128) microprocessor will use the highly purified water from the (126) insulated ultra purified carbonated cold water system/holding tank to make the desired drink.

There is one or more (127) keyboard/verbal display/s enabling the user to control their preferred drink and a (128) microprocessor that has a large data bank of stored information of all known drinking water composition and drinks.

This capability enables the user to program any desired drink imaginable and the (128) microprocessor can send detailed information to the other internal components, to control them and produce the desired drink to replicate any drinking water composition and mixed drinks.

There is a (129) laser flow meter that provides and exact metering of the (7-112) dry and liquid contents that the (128) microprocessor chose for the desired drink.

There is an (130) insulated ultra purified hot water holding tank and (131) an insulated hot water holding tank and a heating element (132), for desired hot drinks.

There is (133) an insulated highly purified water cold water holding tank (134) an insulated cold tap water holding tank and a (135) refrigeration unit for desired cold drinks.

There is a (136) ultra purified slush maker water insulated maker and holding tank for desired slushy drinks. There is a (137) content packet positioning system that monitors the exact location of the (7-112) content packets on the (141) content packet holder conveyor system, so the proper (7-112) content packet lines up properly with the (4) content mixing manifold to make the desired drink.

There is an (138) electric motor, (139) electric motor gear and (140) content packet holder conveyor gear that enables the (128) microprocessor to control the (138) electric motor and turn the (7-112) content holders to there desired position, by means of the (141) content holder conveyor system.

The (129) laser flow rate meter can monitor and regulate the proper amount of contents to the (4) content mixing manifold, then mix with the ultra purified water to the (121) cup/bottle. The (122) mixing drink holder and (123) the ultrasonic mixer produces a well mixed desired drink that the user but not limited to: typed or spoke into the (127) keyboard/verbal display.

The (141) content packet holder conveyor system enables the programmed stored data information from the (128) microprocessor and have the (138) electric motor turn the (139) electric motor gear and the (140) content holder gear to move the (141) content holder conveyor system, so to align the proper (7-112) content packet to the (4) content mixing manifold.

There is a (117) air outlet line that is directly connected to the (4) content mixing manifold, the (115) air pump is directly connected to the (128) microprocessor by means of the (119) input and output leads. The (115) air pump controlled by the (128) microprocessor, which engages and disengages the (115) air pump.

There is a (129) laser flow meter, that is directly connected to the (128) microprocessor by means of the (119) input and output leads. The (129) laser flow meter feeds information to the (128) microprocessor, enabling it to fully control the exact metering, that is required to regulate the amount of flow and quantity of the dry and liquid contents from the (7-112) content packet to the (4) content mixing manifold.

There is a (142) highly purified water hot water inlet line with built in one way valve and a (146) highly purified water hot water outlet line with built in one way valve, that runs to the (4) content mixing manifold. There is a (143) tap hot water inlet line with built in one way valve and a (147) tap hot water outlet line with built in one way valve that runs to the (4) content mixing manifold.

There is a (144) highly purified water cold water inlet line with built in one way valve and a (148) highly purified water cold water outlet line with built in one way valve that runs to the (4) content mixing manifold.

There is a (145) tap cold water inlet line with built in one way valve and a (149) tap cold water output line with built in one way valve, that runs to the (4) content mixing manifold.

These water output lines (146,147,148,149) enable the (128) microprocessor to choose the appropriate water needed to mix with the (7-112) content packets to produce the desired drink.

There is a (150) highly purified slush water inlet line with built in one way valve from the (118) double-distilling unit and a (151) highly purified slush water outlet line with built in one way valve, to the (4) content mixing manifold.

There is a (152) double-distilling unit, outlet water line with built in one way valve to hot-cold and slush tanks, that feeds into the (142) highly purified hot water inlet line with built in one way valve, the (144) highly purified cold water inlet line with built in one way valve.

The (150) highly purified slush water inlet line and the (153) insulated ultra purified carbonated cold water system/holding tank water inlet line with built in one way valve.

The (124) carbon dioxide generator has a (154) insulated ultra purified carbonated cold water system/holding tank water outlet line with built in one way valve going to the (148) insulated ultra purified carbonated cold water system/holding tank water inlet line with built in one way valve, to produce carbonated cold drinks when the (127) keyboard/verbal display informs the (128) microprocessor to perform such task.

There is a (155) left over material removable tray, that holds the contents the (118) double-distilling unit, removed from the (2) intake water source and enables the user to remove and throwaway the unwanted contents, when needed.

There is a (156) power distributor box, to control the input power and a (157) power cord for input power. There is an (158) electric water valve on the ultra purified hot water outlet line with built in one way valve, an (159) electric water valve on the ultra purified cold water outlet line with built in one way valve, an (160) electric water valve on the ultra purified slush water outlet line with built in one way valve.

All electric water valves (158-159-160) are directly connected and controlled by the (128) microprocessor by means of the (119) input and output leads.

There is a (161) vibrating sensor valve, that is placed at the bottom of each one of the (7-112) content packets. The (128) microprocessor sends a signal to the (119) input and output leads to the (113) content holder vibrator that mildly shakes the contents within the (7-112) content packets, this opens the (161) vibrating sensor valve and the contents within the (7-112) content holders, begin to come out into the (4) content mixing manifold.

There is an (162) electric water valve, the (128) microprocessor sends a signal to the (119) input and output leads to the (162) electric water valve and it will open and disperse the exact quantity of ultra purified carbonating cold water from the (126) insulated ultra purified carbonated cold water system holding tank when the user desires a carbonated cold drink.
1. Base of apparatus
2. Water intake source with built in one way valve
3. Dry and liquid content packet holders
4. Content mixing manifold
5. Content gauge
6. Tap water inlet line to the double distilling unit
7. Magnesium (Mg) content packet
8. Sodium (Na) content packet
9. Chromium (Cr) content packet
10. Copper (Cu) content packet
11. Iron (Fe) content packet
12. Chlorine (CI) content packet
13. Manganese (Mn) content packet
14. Selenium (Se) content packet
15. Fluorine (F) content packet
16. Strontium (Sr) content packet
17. Zinc (Zn) content packet
18. Iodine content packet
19. Bicarbonates content packet
20. Carbonates content packet
21. Sulfates content packet
22. Potassium content packet
23. Powdered coffee content packet
24. Powdered tea content packet
25. Powdered whole milk content packet
26. Powdered low fat milk content packet
27. Powdered chocolate content packet
28. Powdered vanilla content packet
29. Powdered strawberry content packet
30. Powdered cranberry juice content packet
31. Powdered grape juice content packet
32. Powdered lemonade juice content packet
33. Powdered fruit punch juice content packet
34. Powdered apple juice content packet
35. Powdered orange juice content packet
36. Powdered strawberry juice content packet
37. Powdered blueberry juice content packet
38. Powdered pomegranate juice content packet
39. Powdered tomato juice content packet
40. Powdered carrot juice content packet
41. Powdered vegetable blend juice content packet
42. Powdered coke soda content packet
43. Powdered lemon-lime soda content packet
44. Powdered root beer soda content packet
45. Powdered orange soda content packet
46. Powdered ginger ale soda content packet
47 . Powdered grape soda content packet
48. Powdered glucuronolactone content packet
49. Powdered glucose content packet
50. Powdered taurine content packet
51. Powdered caffeine content packet
52. Powdered ginseng root content packet
53. Powdered l-carnitine content packet
54. Powdered leucine content packet
55. Powdered whey protein content packet
56. Powdered vitamins—daily allowance content packet
57. Powdered amino acids content packet
58. Powdered sucrose content packet
59. Powdered dextrose content packet
60. Powdered citric acid content packet
61. Powdered sodium citrate content packet
62. Powdered monopotassium phosphate content packet
63. Powdered surose acetate isobutyrate content packet
64. Powdered potassium content packet
65. Powdered guarana seed extract content packet
66. Powdered sorbic acid content packet
67. Powdered benzonic acid content packet
68. Powdered niacinamide content packet
69. Powdered inositol content packet
70. Powdered pyridoxine content packet
71. Powdered hydrochloride content packet
72. Powdered sucralose content packet
73. Powdered maltodextrin content packet
74. Powdered sucralose content packet
75. Powdered folic acid content packet
76. Powdered niacin content packet
77. Powdered pantothenic acid content packet
78. Powdered thiamin content packet
79. Powdered riboflavin content packet
80. Powdered vitamin A content packet
81. Powdered vitamin C content packet
82. Powdered vitamin D content packet
83. Powdered vitamin K content packet
84. Powdered Biotin content packet
85. Powdered Phosphorus content packet
86. Powdered Selenium content packet
87. Powdered Selenium content packet
88. Powdered vitamin B6 content packet
89. Powdered vitamin B12 content packet
90. Powdered molybdenum content packet
91 . Powdered molybdenum content packet
92. Powdered ice tea content packet
93. Powdered pumpkin spice content packet
94. Powdered cinnamon spice content packet
95. Powdered coconut flavor content packet
96. Powdered hazelnut flavor content packet
97. Powdered caramel flavor content packet
98. Powdered toasted almond flavor content packet
99. Liquid coffee extract content packet
100. Liquid vanilla extract content packet
101. Liquid tea extract content packet
102. Liquid sugar content packet
103 . Liquid burgundy concentrate content packet
104. Liquid white wine concentrate content packet
105. Liquid red wine concentrate content packet
106. Liquid rose wine concentrate content packet
107. Liquid sparkling white wine concentrate content packet
108. Liquid fortified wine concentrate content packet
109. Liquid draft beer concentrate content packet
110. Liquid lager beer concentrate content packet
111. Liquid ale beer concentrate content packet
112. Liquid ethanol concentrate content packet
113. Content holder vibrator
114. Content holder electric metering valve
115. Air pump
116. Air intake line
117. Air outlet line
118. Double-distilling unit
119. Input and output leads from microprocessor to all systems
120. Tap water inlet line to hot-cold tanks with built in one way valve
121 . Cup, bottle
122. Mixing drink holder
123. Ultrasonic mixer
124. Carbon dioxide generator
125. Carbon dioxide holding tank
126 . Insulated ultra purified carbonated cold water system/holding tank.
127. Keyboard/verbal display panel
128. Microprocessor
129. Laser flow rate meter
130. Insulated ultra purified hot water holding tank
131. Insulated tap hot water holding tank
132. Heating element with built in temperature control unit
133. Insulated ultra purified cold water holding tank
134. Insulated tap cold water holding tank
135. Refrigeration unit with built in temperature control unit
136. Ultra purified slush maker water insulated maker and holding tank
137. Content packet positioning system
138. Electric motor
139. Electric motor gear
140. Content packet holder conveyor gear
141. Content packet holder conveyor system
142. Ultra purified hot water inlet line with built in one way valve
143. Tap hot water inlet line with built in one way valve
144. Ultra purified cold water inlet line with built in one way valve
145. Tap cold water inlet line with built in one way valve
146. Ultra purified hot water outlet line with built in one way valve
147. Tap hot water outlet line with built in one way valve
148. Ultra purified cold water outlet line with built in one way valve
149. Tap cold water outlet line with built in one way valve
150. Ultra purified slush water inlet line with built in one way valve
151. Ultra purified slush outlet line with built in one way valve
152. Double-distilling unit, outlet water line with built in one way valve to hot-cold and slush tanks
153. Insulated ultra purified carbonated cold water system/holding tank water inlet line with built in one way valve
154. Insulated ultra purified carbonated cold water system/holding tank water outlet line with built in one way valve
155. Left over material removable tray
156. Power distributor box
157. Power cord
158. Electric water valve on the ultra purified hot water outlet line with built in one way valve
159. Electric water valve on the ultra purified cold water outlet line with built in one way valve
(160) Electric water valve on the ultra purified slush water outlet line with built in one way valve
(161) Vibrating sensor valve
(162) Ultra purified carbonating water system electric valve with built in one way valve

### BRIEF SUMMARY OF THE INVENTION

People today prefer a wider variety of drinks than ever. The invention allows the user to but not limited to: for instance type or speak on/at the keyboard display, “mountain water from Switzerland”. Within the microprocessor there is a large data base of minerals and ph balance and other ingredients to be add to highly purified distilled water.

The invention puts in the required contents and the user has the exact tasting water from the mountains of Switzerland. The same holds true for instance flavored coffee, the user will first type in the global location of the drinking water source, for the desired water taste.

Then the user can not only choose but not limited to: the type of coffee to make but also a special added spice/s for their desired flavored coffee taste. The invention enables the user to finely configure the taste of their coffee beyond today's systems due to the ability to incorporate an unlimited variety of drinking water choices.

The invention can also control the rating, from a total decaffeinated coffee to a maximum powered high caffeine and other energy boosting ingredients, to their liking. For juice but not limited to: the user can also choose their desired water taste, from anywhere in the world, then choose one or more of the powdered drink mix and the strength of the mixture as well. Vitamins can be also be added to any drink desired.

The invention allows the user to use their electricity and tap water from their home or business and just refill the dry and liquid packet contents to replicate any drink in the world and beyond.

The invention will produce drinks at a much more economical price, compared to going to a store and purchasing them. This is due to their is no need to transport heavy water, which is the main ingredient of almost all known drinks. The large data base in the microprocessor is user friendly and has all known drink formulas pre-installed, so the user can also fine tune any or all formulas to their own desired taste.

The invention will eliminate or minimize the need for coffee shops and drink coolers in gas stations and small businesses and will make a great addition to a modern home with a device that can produce any drink on the spot.

This invention can eliminate the problems with sour milk, outdated juice drinks, etc. The drink produced will always be fresh and taste exactly the way the user wants it to be, every time.

### BRIEF DESCRIPTION OF THE DRAWINGS

Page I: Front view of invention

Page II: Back view of invention

Page III: Top view of invention—top layer

Page IV: Top view of invention—middle layer

Page V: Top view of invention—bottom layer

### BACKGROUND OF THE INVENTION

The invention was designed to enable but not limited to: a household or business to produce, on site, any drink imaginable from any water source with the using distilled water or tap water and a large variety of content packets.

The microprocessor can make any recipe imaginable and never seen or tasted before. This allows the user to pick a drink from any large grocery store world wide and more, at their finger tips.

What is claimed as new and desired to be secured by Letters Patent of the United States is:

1. An automated drink apparatus capable of producing any drinking water composition items comprising;
A. a base
B. a raw water supply system providing a water source to the apparatus
C. a water purification system that removes almost all elements from said water supply producing ultra purified water
D. a content packet system with one or more packets that contain minerals and trace elements found in every known drinking water composition
E. a mixing system that combines and mixes said minerals and trace elements with said ultra purified water to produce drinking water
F. a microprocessor system with a stored data base capable of configuring and replicating any known drinking water composition with an almost unlimited variations of said drinking water compositions
G. a keyboard/verbal display panel, controlling all said systems enabling the user to choose any said drinking water composition conceivable to be produced by said apparatus

2. The automated water drink apparatus as recited in claim 1, wherein items further comprises;
A. a content packet holder conveyor system enabling the microprocessor to move the content packets
B. a content packet positioning system enabling the microprocessor to properly position the content packets

3. The automated water drink apparatus as recited in claim 2, wherein items further comprises;
A. a content mixing system enabling the microprocessor to control the proper mixing of said minerals and trace elements with said ultra purified water

4. The automated water drink apparatus as recited in claim 2, wherein items further comprises;
A. one or more distilling units for purifying said raw water into said ultra purified water

5. The automated water drink apparatus as recited in claim 2, wherein items further comprises;
A. an insulated ultra purified cold water holding tank for storing said ultra purified cold water
B. an insulated tap cold water holding tank for storing said tap cold water
C. a refrigeration unit with built in temperature control unit, providing cooling for the said insulated cold tanks

6. The automated water drink apparatus as recited in claim 2, wherein items further comprises;
A. an insulated ultra purified hot water holding tank for storing said ultra purified hot water
B. an insulated tap hot water holding tank for storing said tap hot water
C. a heating element with built in temperature control unit providing heating for the said insulated hot water tanks

7. The automated water drink apparatus as recited in claim 2, wherein items further comprises;
A. an insulated ultra purified carbonated cold water system/holding tank for holding said purified carbonated cold water
B. a refrigeration unit with built in temperature control unit, providing cooling for the said insulated ultra purified carbonated cold tanks

8. The automated water drink apparatus as recited in claim 2, wherein items further comprises;
A. an ultra purified slush maker water insulated maker and holding tank for holding said ultra purified slush
B. a refrigeration unit with built in temperature control unit, providing cooling for the said insulated ultra purified slush tank

9. The automated water drink apparatus as recited in claim 2, wherein items further comprises;
A. additional content holders containing a variety of contents other than minerals and trace elements that can be added and mixed into said minerals and trace elements with said ultra purified water
B. said microprocessor system contains additional stored data with the capability to configure and replicate any known mixed drink composition enabling said apparatus to produce an almost unlimited variations of any known mixed drink composition by means of said capability of configuring and replicating any known drinking water composition with said almost unlimited variations of said drinking water compositions
